(19) United States
(12) Patent Application Publication
(10) Pub. No.: US 2007/0210113 A1
(43) Pub. Date: Sep. 13, 2007

(54) Dispensing Container

(76) Inventors: Amir Genosar, Lafayette, CO (US); Ilan Solomon, Jarusalem (IL)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/578,736

(22) PCT Filed: Nov. 9, 2004
(86) PCT No.: PCT/IL04/01024

§ 371 Date: Jan. 3, 2007

(30) Foreign Application Priority Data
Nov. 16, 2003 (IL) 158857
Nov. 4, 2004 (IL) 165028

(51) Int. Cl. B65D 37/00

(52) U.S. Cl. 222/207

(57) ABSTRACT

The invention provides a container (10) having a dispensing outlet (19). A section of the container (10) adjacent to the outlet is provided with a pumping assembly (17) sized to be insertable into the section via the outlet and includes a pumping button (12). The button (12) is a section of the container wall (14) and depression of the button (12) actuates the pumping assembly (17).

### FIELD OF THE INVENTION

The present invention relates to the field of dispensers and packaging. More specifically, the present invention relates to a container for the controlled dispensing and dosing of liquid products, and a method for fabricating said container wherein a pumping assembly is inserted into the end of said container. More specifically, the present invention relates to a container assembled in this manner, wherein a section of the container wall serves as a pumping button activating said pumping assembly in order to expel the contents of the container.

### BACKGROUND OF THE INVENTION

Various forms of dosing packages are becoming increasingly popular. Such packages include rigid bottles with a dispensing pump mounted on the bottleneck, and dispensing bottles where the contents are squeezed out by squeezing the bottle with a hand. The former are typically used for liquid soap and various other personal care products such as shampoo. The latter are often used for condiments such as ketchup, chocolate sauce, etc.

The dispensing bottle, where the package walls are squeezed, represents a simple and inexpensive form of a dispensing package, albeit one where the user's control over the dispensing is very limited. On the other hand, while dispensing pumps afford good dosing control, they are expensive to produce. In an effort to bridge the gap between these two concepts, a number of dispensing-package designs based on performing a pumping action via the package wall while integrating a pump mechanism, have been proposed. For example, the prior art contains a number of examples in which a pumping bulb is formed from part of the wall of the package, where the pressure applied on this pressure bulb operates an integral pumping mechanism: U.S. Pat. No. 3,715,060 describes a dispenser in which the neck of the container incorporates a swelling which forms a pressure bulb, via which an integral pumping mechanism is operated; U.S. Pat. No. 4,201,317 and U.S. Pat. No. 4,336,895 describe a variable volume pump chamber in the shape of a bellows with a finger operated actuator which may include an integrally molded trigger; U.S. Pat. No. 5,261,755 describes a dispenser in which a bulbous section of the dispenser can be pressed in order to apply pressure onto the fluid contents of the dispenser and thus eject it from the container; U.S. Pat. No. 5,303,851 describes a blow-molded dispensing bottle with a liquid conduit provided from the base of the bottle to its neck, where said conduit features a compressible pressure bulb for pressing to dispense the contents; U.S. Pat. No. 5,601,212 describes a similar bottle with a trigger-operated pressure bulb pump; and WO 02/16047 A1 describes a fluid dispenser with an actuator located directly beneath an actuating wall which is pressed upon to expel the contents of the pumping chamber. While these prior art devices disclose the use of a section of the container as a pumping button for an integral pump, they all share the disadvantage that they constitute dedicated forms of packaging that are not adapted for ready fabrication on existing production lines. Furthermore, none of these prior art devices is designed for fabrication on a standard tube, bottle or tottle production line.

Further prior art devices include a number of less relevant dispenser designs: U.S. Pat. No. 2,715,236 describes a rigid liquid. applicator in which a flexible button component serves to complete a pumping chamber when depressed; UK application GB 2083142A describes a rigid container with a flexible curved wall in the nozzle part leading to a lip valve at the outlet; U.S. Pat. No. 4,330,071 describes a dispenser in which a semi-spherical pressure bulb serves as a pumping button; U.S. Pat. No. 4,651,904 describes a dispenser with a press-button on the side of the nozzle which presses an accordion or bellows; U.S. Pat. No. 5,601,212 describes a squeezable long connecting nipple for attachment to a bottle thread; and commercial products in which a conventional dispensing pump is inserted into. the end of a tube, such as the Precitube® (Cebal SAS, Gennevilliers, France). All these devices represent designs in which either the pumping button is not a section of the wall of the container, or the pumping mechanism is an external one as opposed to an integral one.

Further prior art includes a number of devices in which a separate, non-wall section of the container serves as a pumping button, as per U.S. Pat. No. 3,361,305; application EP 0810160 A2; U.S. Pat. No. 4,795,063 and U.S. Pat. No. 5,871,126.

Thus there is no description in the prior art of a container having an pumping mechanism inserted into its neck, said mechanism then functioning as an integral pump wherein a section of the wall of said container serves as a pumping button.

The present invention refers to such a container in which this configuration is supported. Currently available containers appropriate to the current invention include both tubes, bottles and “tottles”, where a tottle is a tube manufactured like a molded blow-molded bottle instead of extruded like a conventional tube. Accordingly, the term “container” as used in this disclosure refers to tubes, bottles and tottles, except where otherwise identified. As regards tubes, an additional cost factor in their production is the need, typically, to insert a tube head and provide a cap in order to complete the product. The design of the present invention can obviate this requirement as described below.

It is therefore the object of this invention to provide a dispensing container containing an integral dispensing mechanism wherein a section of the container wall serves as a button which actuates said dispensing mechanism and wherein said integral dispensing mechanism incorporates a pumping assembly which is fitted into a neck of said container.

It is also the object of the present invention to enable a method of fabricating a dispensing container, said method consisting of inserting a pumping assembly into an open end of said container such that the button section of the container wall is aligned with the pumping chamber cavity of said assembly; thereby ensuring that depression of said button will serve to actuate the pumping mechanism so formed.

It is a further object of this invention to prevent any unintentional dispensing of the contents of the container caused by squeezing of the container body as opposed to pressing the button.

It is furthermore the object of the present invention to enable simple and inexpensive fabrication of said containers based around the use of an injected plastic part which is inserted into the container on a relatively standard tube, bottle or tottle production line.

It is a still further object of this invention when fabricating a tube, to obviate the need to insert the tube head and provide a cap as additional plastic parts in order to fabricate a complete working tube product; thereby achieving additional functionality without adding to the cost or complexity of the fabrication stages.

These and other objects. of this invention will become more evident in the. summary of the invention and in the description of the preferred embodiment.

### SUMMARY OF THE INVENTION

According to the present invention there is now provided a container having a dispensing outlet, a section of said container adjacent to said outlet being provided with a pumping assembly sized to be insertable into said section via said outlet and further being provided with a pumping button; wherein said button is a section of the container wall and depression of said button actuates said pumping assembly.

In preferred embodiments of the present invention, said section of said container adjacent to said outlet is a neck area thereof.

Thus in preferred embodiments of the present invention there is provided a dispensing container comprising a container neck into which a pumping assembly is inserted to form an integral dosing pump. At least one pumping button is provided in the wall of the container where said button is aligned with the pumping chamber of said pumping assembly. The integral dosing pump so formed comprises an inlet valve leading into the container, a non-return product dispensing valve and a pumping chamber which is internal to the container; the arrangement being such that said dispensing container is formed as a compact, self-contained unitary container and pump and depression of the pumping button to its displaced position causes the contents of said pumping chamber to be expelled via said product dispensing valve and return of said button to its first normal position causes the contents of the container to enter said pumping chamber via said inlet valve.

In a preferred embodiment of the present invention said button comprises a molded, embossed or thermoformed section of the wall of the container.

In still further preferred embodiments of the present invention two such said buttons are provided, one along each along each side of the container.

As will be realized, the present invention relates to a packaging system and method of assembly offering greater convenience than that provided by existing systems, while retaining the form factor of a standard tube, bottle or tottle. Unlike other systems which require the addition of an external pumping mechanism to a tube, the concept of inserting a pumping assembly so as to create an integral mechanism operated by a button section of the container wall, enables a more. natural integration of pump and container, with a low parts count. Advantageously, the pumping assembly is inserted into the neck of the container in a simple manner, thereby increasing the speed of assembly and ensuring that the container of the present invention is simple to fabricate on existing or only slightly modified production lines. The pumping assembly may be either partially or fully inserted into the neck of the container. Appropriate insertion methods for accomplishing this include press-fit and snap-fit of a finished part; or head-injection whereby all or part of the pumping assembly is injected in situ within the tube ending. In the case where the assembly involves press-fit or snap-fit, a welding and/or adhesion step may additionally be used as required to improve the seal. Where a head-injection is performed, the seal to the tube wall is achieved by means of this injection, with the remainder of the pumping assembly (if any) being inserted through either end of the tube to connect to the head-injected part.

The button(s) serves to pump out the liquid contents of the tube of the present invention in measured doses. The pressure resulting from the depression of the button causes the liquid in the pump chamber to be forced out of the outlet valve, where it exits via the nozzle connected to this valve. When the button is released, said button is arranged to regain its former position or shaper either due to a spring action or due to the button's internal structural stress. This causes low pressure within the tube, which in turn causes the liquid contents to fill up the pumping chamber via the inlet valve.

In the case that an air-compensation path into the container via the pumping assembly is provided, the container retains its shape as the contents are expelled over time; which is better from an ergonomic point of view as the container remains firm and easy to hold. However, in the case that air-compensation is not provided, the container will gradually collapse as its contents are expelled. In this case, good ergonomics may be maintained by employing a tube-inside-tube construction, whereby the inner tube collapses while the outer one retains its constant shape.

In a preferred embodiment of the invention which relates to tubes (as opposed to tottles), the button is a thermoformed or embossed section of the side of the tube, where said thermoformed or embossed section can be pretreated to attain the desired mechanical properties by a number of methods, including but not limited to local coating, laminating and heat treatment. In the case that a tottle is used, the button can be formed as part of the blow molding or injection molding of the tottle.

In a further preferred embodiment of the invention, the button is not deformed but is merely a marked area on the container surface. In this case, the depression and return to first position of said button are a function of the inherent tendency of the material from which the container is fabricated to bend and return to its initial shape. Advantageously, this design saves the manufacturing step of forming the button.

In a still further embodiment, the pumping assembly comprises a single injection-molded plastic component and one external elastomeric diaphragm.

In a still further preferred embodiment, the pumping assembly comprises a single injection-molded plastic component including all valves.

In a still further preferred embodiment, said plastic component further comprises the nozzle.

In a further preferred embodiment of the invention, dispensing of the liquid contents of the container is only possible by depressing the button provided, whereas squeezing of the package as a whole serves to prevent any dispensing occurring. In this manner, an “anti-squeeze” functionality is enabled.

In a further preferred embodiment of the invention an extra member is provided to protect the pumping button while not in use. Said member can be a separate cap or flap or an integral extension of the plastic injection-molded component.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

The invention is herein described, by way of example only, with reference to the accompanying drawings, wherein:

FIGS. 1a, 1b and 1c provide an isometric view illustrating the main components of a preferred dispensing tube according to the current invention in both exploded and assembled views;

FIG. 2 shows a cut-away isometric view showing the placement of the rigid plastic part inside the tube;

FIGS. 3a and 3b show cross-sectional views of the pumping chamber being activated by a thermoformed button, said button being shown in both its first normal and its second depressed positions;

FIGS. 4a, 4b, 4c and 4d illustrate the operation of the pumping assembly comprised of a plastic component with an external diaphragm; with FIGS. 4a and 4b showing isometric views and FIGS. 4c and 4d showing upper cross-sectional views.

FIG. 5 provides a cross-sectional view illustrating the operation of the pumping assembly comprised of a plastic component which incorporates the valves;

FIGS. 6a, 6b and 6c show isometric views of the post-injection and assembled configurations of the plastic component shown in FIG. 5;

FIG. 7a, 7b and 7c are views of the pumping assembly of the present invention; and

FIGS. 8a, 8b, 8c and 8d provide isometric views showing the insertion of a pumping assembly in to an upside-down bottle.

### DETAILED DESCRIPTION OF THE DRAWINGS

The present invention will be described in detail according to the preferred embodiments illustrated in the accompanying drawings. Like reference numerals are used to identify identical components in the various views.

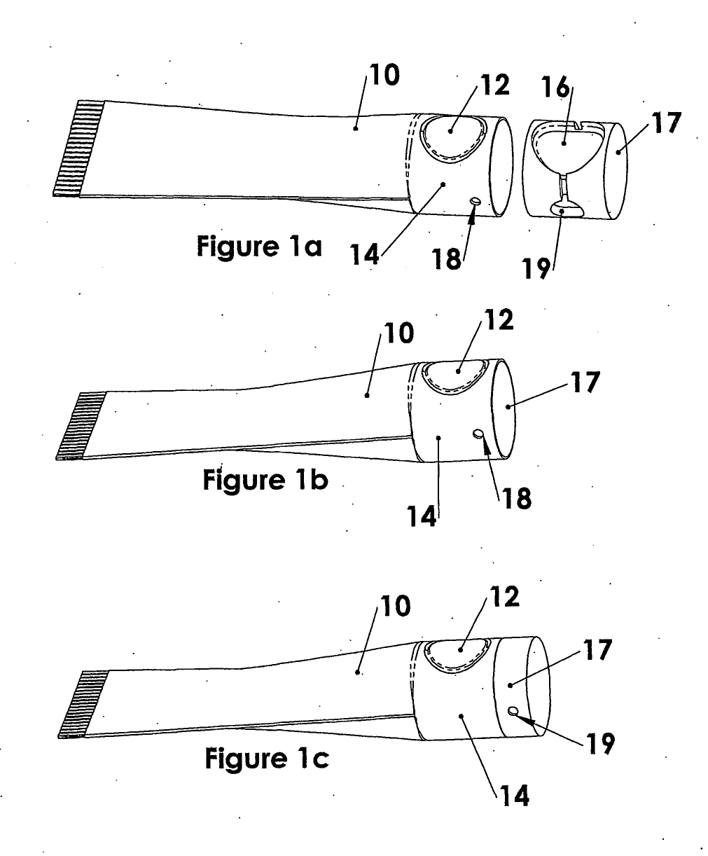

Referring to FIG. 1, an overview of a preferred embodiment of a dispensing tube according to the present invention is shown. FIG. 1a shows an exploded view of the tube 10 prior to assembly, showing the button 12 as a thermoformed or embossed section of the tube wall 14. Also shown is the pumping chamber 16 of said pumping assembly 17, which is aligned with said button section 12 on assembly. Two assembled configurations of this embodiment are shown in FIGS. 1b and 1c respectively, both as on-the-head type tubes. In FIG. 1b, the pumping assembly 17 is entirely inserted into the end of the tube 10 such that the end of the assembly 17 is flush with the end of the tube 10. In this case, a hole 18 is shown cut into the tube wall so that the nozzle 19 may issue the contents through said hole 18. Alternately said hole can be replaced with a notch starting at the edge of the tube, and the nozzle in the injected plastic part will slot into said notch on assembly. The advantage of this latter configuration is that no extra manipulation is required at assembly in order to align the nozzle 19 with the hole 18. In FIG. 1c, a slightly different pumping assembly 17 is shown assembled into the tube 10 such that only part of the assembly 17 is inserted, and the nozzle 19 is implemented in the exposed part of the pumping assembly 17. This method of tube fabrication shown in FIG. 1a through 1c may be readily implemented on a tube production line, and enables the inexpensive fabrication of a dosing tube with a sharply reduced parts count. Advantageously, whereas tubes typically terminate in either a dispensing cap or a formed nozzle with a screw thread and cap, this embodiment can also obviate the need to incorporate either of these traditional termination components, thereby further reducing complexity and cost. In this ergonomically advantageous configuration, the tube 10 may be easily grasped in the palm of the hand, while the thumb depresses the button 12. While the nozzle 19 may be located at any point in the side or base of the pumping assembly, in a further ergonomically preferred embodiment, the orientation of the nozzle 19 is approximately at right-angles to the pressure on the button, as shown. Advantageously, where the nozzle 19 is approximately flush with the tube wall (as per FIGS. 1a and 1b) or with the exposed part of the pumping assembly (as per FIG. 1c), a shipping seal (not shown) may be easily added by merely applying tape across the nozzle. If required, a further button may be located on the opposite side of the tube (not shown), aligned with an extension of the pumping chamber located beneath that point. The nozzle 19 may be terminated by any form of cap, closure or shipping seal, as known in the art. Said caps, closures or seals may be further enhanced with a tamper-evident seal as is known in the art.

The sleeve of the dispensing tube of the present invention may be fabricated from any laminate or plastic tube. materials, or from plastics appropriate to a tottle, as long as the mechanical properties of such materials, together with the geometry of the pump, provide the performance and tactile characteristics required and are chemically compatible with the contents. Appropriate tube laminate materials include but are not limited to the list including polyethylene, EVOH, maleic anhydride copo-ethylene, in various multi-layer combinations with appropriate adhesives. Foil laminates may further incorporate aluminum or other metalized foil layers for high-barrier applications. Plastic tube materials include but are not limited to mono-layer polyethylene in various densities; co-extruded plastic combining polyethylene, EVOH, and adhesive; and an aluminum layer for high-barrier applications. Plastics suitable for tottle fabrication include but are not limited to extruded or blow-molded high-density polyethylene (HDPE), LDPE, MDPE, PETG, EVOH and PVC.

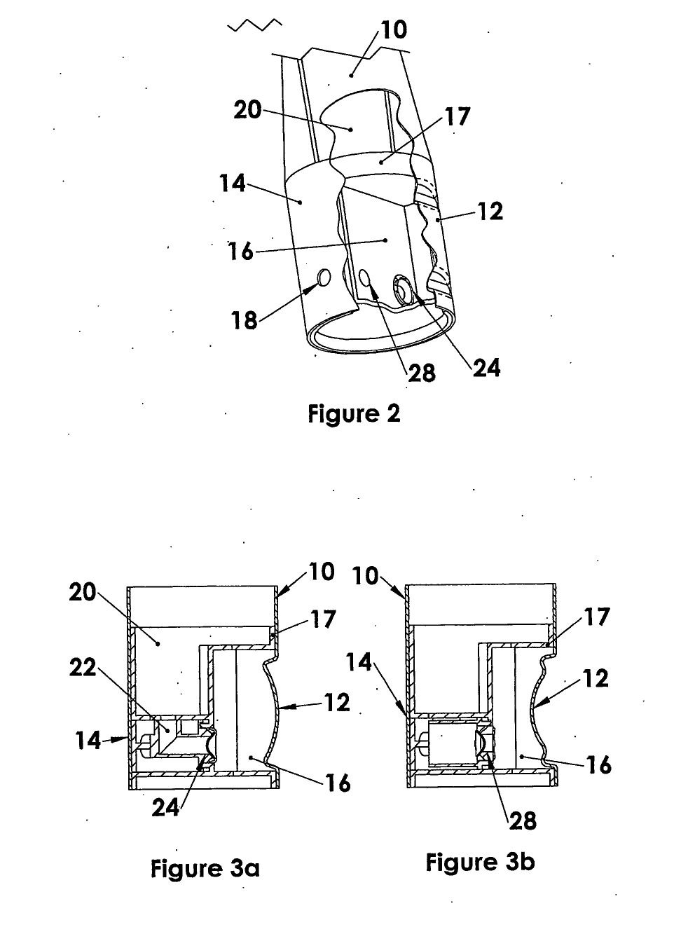

Referring now to FIG. 2, a preferred embodiment showing the role of the pumping assembly 17 within the tube 10 is shown in a cut-away diagram. The contents 20 of the tube 10 enter the pumping assembly 17 via the inlet channel 22 of the pumping assembly and non-return inlet valve 24, in order to reach the pumping chamber 16. On depression of the button 12 to its second or depressed position, the contents of the pumping chamber 16 are dispensed via non-return outlet valve 28 to the nozzle 19. The button 12 then returns to its first normal or initial position due to its internal stress. As it does so, low pressure in the pumping chamber 16 causes further contents 10 of the tube to enter said chamber 16 as stated above. If no air-compensation is provided, the dispensing of the contents 10 in this manner will cause the gradual collapse of the tube 10; albeit the tube 10 can then be used in any orientation. On the other hand, where an air-compensation route (not shown) is provided, the tube will maintain its shape due to the fact that air takes the place of the ejected contents. In this latter case, in order to maintain fluid contact between the contents 20 and the inlet channel 22, the tube of the present invention must be used in an on-the-head configuration (or provide an uptake tube to the location of the contents). Note that in some cases, it is advantageous to keep the contents 20 air-free while also maintaining the external form of the tube (for ergonomic reasons). In this case, a double sleeve arrangement (not shown) may be used in which the inner sleeve is a collapsible tube wall while the more rigid outer sleeve maintains its shape, with venting being provided between the two sleeves. Another means of maintaining the tube's shape without the need for air-compensation is the use of a piston located at the far end of the tube, said piston gradually advancing as the content is dispensed. Said piston may be supported with a spring in order to overcome friction and to assist the return of the pumping button to its initial position.

Referring now to FIG. 3, a cut-away view of the pumping chamber 16 being activated by a preferred embodiment of a formed toggle button 12 is shown. For a regular tube, such a button 12 may be formed by thermoforming or embossing the tube wall 14. However, advantageously, when using a tottle, such a button 12 may be formed as part of the blow-molding (or injection molding) of the tottle itself. Said button 12 may be toggled between a first normal position as per FIG. 3a, and a second depressed position as shown in FIG. 3b. The button 12 is typically depressed by the consumer pressing it with a thumb. When the consumer then removes his/her finger or thumb, the button is automatically restored to its initial position due to the internal stress within the plastic. Also shown in this view are: the channel leading into the pumping chamber 16 through the non-return inlet valve 24; and the channel leading from the pumping chamber 16 to the non-return outlet valve 28. Depression of the button 12 causes the contents of the pumping chamber 16 to be expelled along the channel to the outlet valve 28; while the return of the button 12 to its first position causes low pressure within the chamber 16, which in turn causes additional uptake of the tube contents 10 via the channel from the inlet valve 24. The functioning of the button 12 is dependent not only on its shape but also on its thickness and mechanical properties such as its elasticity. For example, a thicker button will tend to have a pure toggle action in that, when pressed, it will rapidly jump ahead to its fully depressed position. However, a thinner or otherwise less stiff button will need the consumer's depression action to continue further towards the fully depressed position. In terms of the volumes dispensed in each case, the former case will always produce a fixed dose, whereas the latter will dispense a volume, which is a function of how deeply the button was pressed. Also falling into the latter category is the case mentioned above where the button 12 is merely a marked section of an otherwise un-contoured tube wall. In this case, the depression of the button is merely the deformation of a cylindrical section of the tube wall into the cavity of the pumping chamber. In this way, a well-performing pump can be achieved even without making the deformation in the wall described above; but rather simply exploiting the fact that the tube wall is curved. However, the thermoformed button design is more flexible in both design and performance.

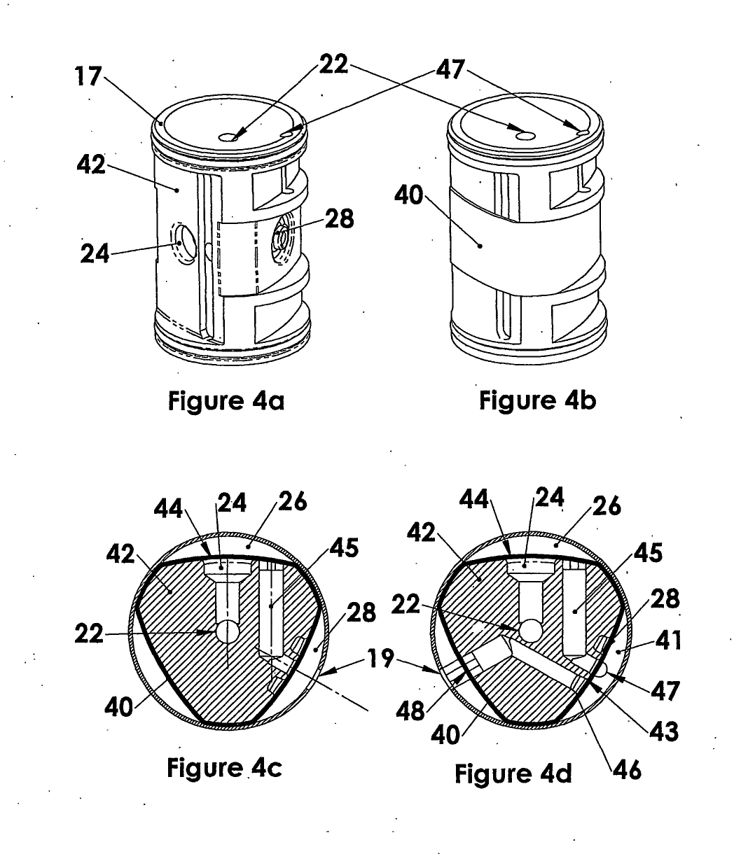

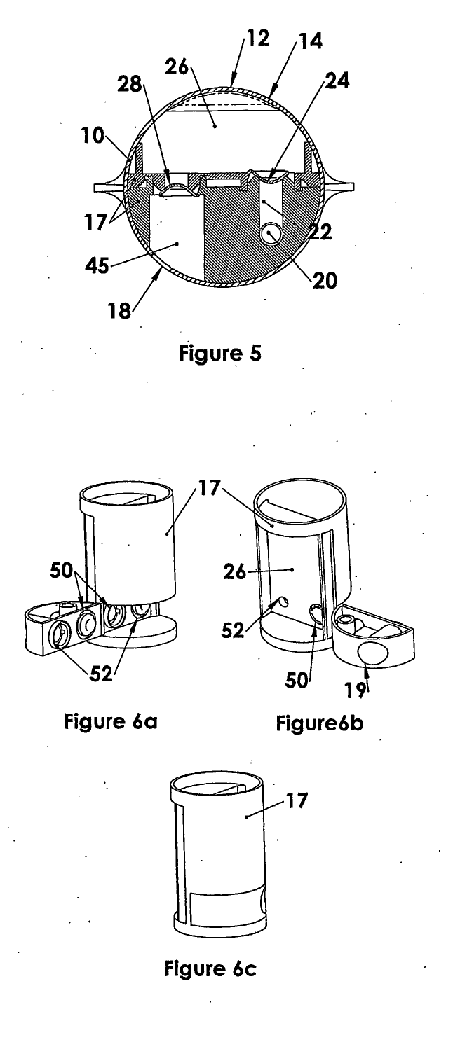

The above description of the dispensing tube of the current invention is generic in the sense that it does not describe the details of the valves used and the engineering approach used in fabricating said valves within the pumping assembly. FIGS. 4 and 5 below illustrate two distinct engineering approaches to this question of valve implementation, but the generality of this patent is not limited to a specific valve type, and thus the invention claimed can use either of these valve types, any combination of the two, or any other valve design approach.

Referring now to FIG. 4, a preferred embodiment of the pumping assembly 17 is shown, in which an external diaphragm 40 serves to complete the valves. FIG. 4a shows an isometric view of the plastic component 42 of the pumping assembly showing the channels and chambers it defines, while FIG. 4b shows the same view but with the diaphragm 40 in place around it or surrounding it. Referring now to FIG. 4c, the view from above (i.e. from the tube interior) shows the inlet channel 22 leading down into the plastic component 42 and then along into the pumping chamber 16. The entry of said inlet channel 22 into said pumping chamber 16 is barred by the diaphragm 40, such that, when there is low pressure in the pumping chamber 16, the diaphragm section marked 44 is pulled away from the inlet channel 22 (where it enters the pumping chamber 16), enabling the tube contents to enter said pumping chamber. In this manner, the diaphragm at the point where the inlet channel 22 enters the pumping chamber 16 functions as a non-return inlet valve. Similarly, the outlet channel 45 leads from the pumping chamber 16 to the nozzle 19, and the diaphragm section 46 at said channel's exit from the pumping chamber 16 serves as an outlet valve 28 which only opens when the button 12 is pressed, causing high pressure in the pumping chamber 16. Note also that this high pressure in the pumping chamber 16 causes the inlet valve 24 to seal at this time.

Referring now to FIG. 4d, a further preferred embodiment of this implementation of the pumping assembly is shown. In this embodiment, the outlet channel 45 does not lead directly to the nozzle 19 but instead the outlet valve 28 is a pressure valve (as opposed to a check valve) and is located in an outlet chamber 46 which is physically removed from the nozzle 19. Said outlet chamber 46 is separated by the diaphragm 40 into a pressure cell 41 on one side and the fluid path from the pumping chamber 16 to the nozzle 19, on the other side 43. The fluid in the pressure cell 41 does not participate in the flow path. The path in the outlet chamber 46 is arranged such that an increase in pressure in the pressure cell 41 will choke the flow path 43 by pressing the diaphragm 40 toward it. This outlet valve 28 will open whenever the pressure in the pumping chamber 16 rises, i.e. on a pumping action. The pressure cell 41 is in fluid contact with the body of the tube and thus, when the pressure in the interior of tube rises, the outlet valve 28 will shut-off. This functionality prevents the dispensing of the tube's contents that would otherwise occur on simply squeezing the tube (as opposed to pressing the button 12). In this way, an anti-squeeze functionality can be implemented. As shown, a pressure channel 47 leads from the interior of the tube to said outlet chamber 46, serving to close the outlet valve 28. Only when the pressure from the outlet channel 45 is greater than that conveyed from the interior of the tube will the outlet valve 28 open and enable the content of the pumping chamber to flow to the nozzle 19. If required, a spring may be implemented in the above described pressure valve to support either its opening or closing, in accordance with the content and the valve design.

Suitable materials for the diaphragm shown in FIG. 4 may be any elastomeric material with appropriate elastic performance, providing that it meets the minimum requirements in terms of shelf-life, fatigue resistance over the planned use period, compatibility with the chemical and mechanical properties of the contents, and suitable mechanical properties in terms of the valve design. Suitable elastomeric materials include silicone rubber, Santoprene® from Advanced Elastomer Systems, L.P. (Akron, Ohio, USA), and NBR (nitrille butille rubber).

As will be obvious to one skilled in the art, a pressure compensation valve can be implemented in the pump assembly shown. A pressure compensation valve is a check valve or a pressure valve, which opens toward the direction of the interior of the tube when the pressure outside the tube is greater then the pressure in. the tube. Such a compensation valve can either be a stand-alone feature or combined within the dispensing flow path. As shown in FIG. 4, in this preferred embodiment, said air-compensation mechanism is combined within the dispensing flow path. To accomplish this, a bypass groove (not shown) is implemented at the fluid exit point 48 of the pump assembly 17, ensuring that the diaphragm does not block “opposite flow” (i.e. the flow of air into the mechanism). Thus, the moment the pressure drops inside the tube the diaphragm section 46 in the outlet chamber 41 will be forced to separate from the flow path 43 enabling air to flow into the pressure cell and from there into the tube interior.

Referring now to FIG. 5, a further preferred embodiment of the pumping assembly is shown. In this embodiment the valves are implemented in plastic as described below. The inlet channel 22 conveys the material to be dispensed from the interior of the tube as per FIG. 4 above. At the entry point of said channel to the pumping chamber 16 an inlet valve 50 formed using a dome and sealing lips is implemented in plastic such that said valve will only open when there is low pressure in the pumping chamber 16. Similarly, the outlet valve 52 leading from the pumping chamber 16 to the nozzle 19 is a similarly constructed non-return valve, oriented such that high pressure within the pumping chamber 16 (as a result of the consumer pressing the button 12) causes this valve to open and the contents to be expelled via the outlet channel 45 to the nozzle 19. Said high pressure will also ensure that the inlet valve 50 remains closed during this button depression operation. If required, a spring may be implemented in one or more of the above described valves to support either their opening or closing, according to the content type and the valve design.

Referring now to FIG. 6, post-injection and assembled views of the plastic component shown in FIG. 5 are provided respectively. As a completed valve cannot be injection molded directly (as the dome would attach to the sealing lips), this preferred embodiment shows the pumping assembly as it emerges from the injection-molding machine, showing the plastic inlet valve 50 and outlet valve 52; each with the dome separated from the sealing lips. The hinge 60 enables the two sides of this plastic component to be mutually engaged, such that the valves sections are assembled into complete working valves, as shown in FIG. 5. The use of this type of valve enables this component to be produced as one part. In a further preferred embodiment, said plastic component can be produced in two halves and then assembled.

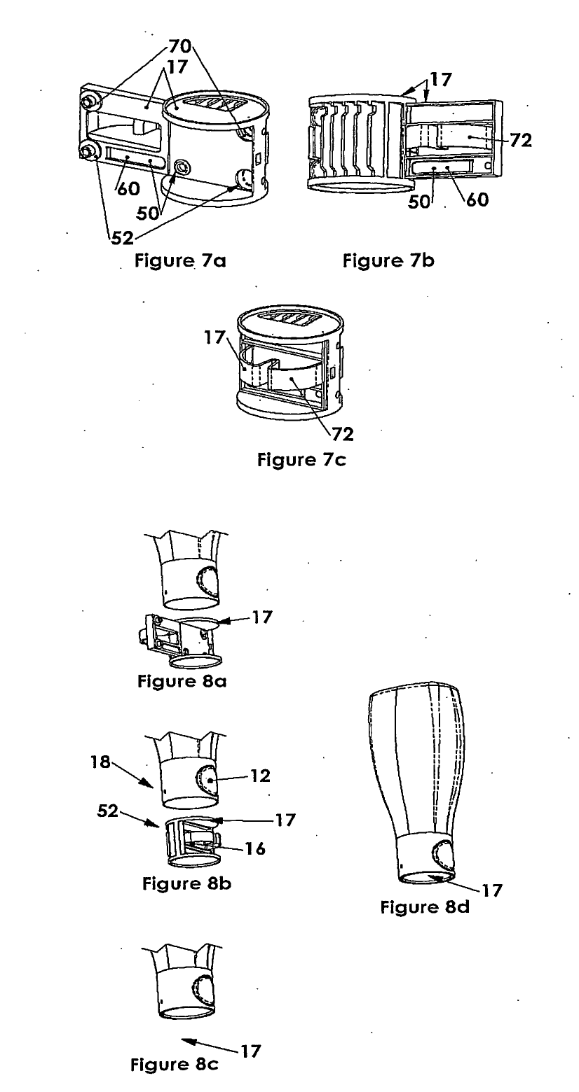

Referring now to FIG. 7, a further preferred embodiment of the pumping assembly 17 of the present invention is shown. In addition to the inlet valve 50 and outlet valve 52 already provided in the embodiment shown in FIG. 6, this embodiment further provides an air compensation valve 70 integral to the design and also an integral spring 72. As before, the completion of the valves is accomplished by mutually engaging the two sides of the pumping assembly 17 as per FIG. 7c, either making use of a live hinge 60 or, alternatively, fabricating the pumping assembly using two parts (not shown). Advantageously, the inclusion of an air compensation valve 70 in the pumping assembly ensures that this pumping assembly design approach is suitable for non-collapsible dispensing packages. Accordingly this approach is suitable for use in fabricating dispensing bottles, tottles and non-collapsing tubes. Where it is used in tubes, it enables the maintenance of the external form of the tube without requiring the use of a collapsing inner tube sleeve.

FIG. 8 illustrates the steps involved in fabricating an upside-down bottle based on the pumping assembly shown in FIG. 7. FIG. 8a shows the pumping assembly 17 prior to the engagement of its two sides. FIG. 8b then illustrates the pumping assembly 17 after said engagement has been performed; and FIG. 8c shows the pumping assembly 17 after its insertion into the bottleneck 80. Note that the pumping assembly 17 is oriented such that the pumping chamber 16 is located directly beneath the button 12, and the nozzle 18 is connected to the outlet valve 52. Advantageously, the presence of the integral spring 72 ensures button restitution without relying on the internal stress of the container wall material. This in turn means that relatively thin and inexpensive materials can be used for the bottle construction, thereby reducing overall costs. FIG. 8d shows an assembled bottle incorporating the pumping assembly 17 described in FIG. 7 after the insertion step. Said insertion step may be either snap-fit or press-fit and/or may also involve a welding step to improve the seal obtained. Suitable materials for fabricating such a bottle include PET, PVC, and PE, where fabrication from PET requires injection-blow-molding instead of blow molding.

The plastic component(s) of the pumping assembly can be produced from any injectable plastic, as long as it satisfies the mechanical requirements for the specific design and container contents, including but not limited to PP, PE, and PVC. The valve mechanisms used for the inlet and outlet valves may be any type of pressure valve or check-valve as known in the art. In addition to the membrane valves shown above, any other type of spring or leaf valve may be used, and their orientations may be either parallel (in-line) to or perpendicular (deviated) to the liquid flow.

Advantageously, by having a delay in the return of the outlet valve to its closed position, a small suck-back from the nozzle will be gained, and this is useful in keeping the end of the nozzle 19 clean after use. Such a delay can be achieved by several methods, including having a long travel of the sealing element between its open and closed positions, by a viscous interaction between the sealing element and the fluid as it moves, or by making the sealing element out of elastic materials with large tensile hysteresis.

The container of the present invention may be filled by any of the methods known in the art for filling a bottle or tottle, including but not limited to: (a) filling through the neck or open end prior to inserting the pumping assembly, and (b) filling through a hole in the base while the container is held in its upside-down position and the fabrication of the pumping assembly into the neck has already been performed. In the former case, the container may be squeezed slightly before the pumping assembly is inserted, where this squeezing is then released as the pumping assembly is inserted, in order to avoid a build-up of pressure in the container due to the insertion. In the latter case, the filling hole in the base may be closed using induction sealing. In the case of a tube, the filling may take place from the far end of the tube before said end is welded closed.

As will be obvious to those skilled in the art, a number of alternative embodiments exist for the nozzle part of the dispensing container of the present invention, including but not limited to such structures as needle and catheter-type nozzles. For example the nozzle may terminate in a cap or other closure; the nozzle may be a rotating one, either with or without a shut-off valve; the nozzle may incorporate a special applicator such as a brush for paints, a dropper for eye drops or nasal drops, a foam pad for polish application or a shaping nozzle for food decorations. A notch feature on the nozzle may serve to snap off a tamper-proof portion at the end of the nozzle. Alternative or additional seal and tamper proof indication may be provided by a foil layer covering said nozzle. The nozzles employed may be either rigid or flexible. Additionally, either the nozzle or the pumping assembly can include an additional cut-off valve. Such a manually actuated safety valve, preferably one that cannot be operated by a young child, provides an important safety feature.

As will be obvious to one skilled in the art, it is possible to provide a duplication of the pumping mechanism within a single container such that it could contain a plurality of parallel pumping mechanisms. Example applications for such an embodiment include: one mechanism for oil and one for vinegar for making a salad dressing; one for mustard and one for ketchup for providing a combination of condiments; one for shaving gel and one for aftershave to provide a complete shaving application kit; and two separate chemicals for a medical diagnostic, etc. In such an embodiment, a plurality of inner chambers or sleeves can be used within the container, one connecting to each pumping mechanism in order to dispense each substance separately. Alternatively, just a single pumping mechanism could be provided, where a plurality of substances is mixed either (a) at the time of dispensing, or (b) prior to dispensing by means of an appropriate manually-operated valve. Additionally, one or more of said chambers could be integrated into the pumping assembly, and introduced into the dispensed stream by activating a further button in said assembly. An additional means of introducing a further liquid into the container of the present invention is to provide a septum in either the plastic wall of the container or the pumping assembly, whereby an external liquid can be injected into the container via said septum. This feature is important in medical applications. Within the context of dividing the container into sections, it is also possible to have part of the container implement the dispensing mechanism as described above, while having a further section of the container constitute an isolated compartment. Said isolated compartment may serve to hold additional products that are in some way related to, or used in conjunction with, the contents of the container. For example, said compartment may hold (a) a razor and shaving blade, thereby comprising a complete shaving travel kit in conjunction with the gel and aftershave contents of the container as described above; all within a single container product; (b) a paintbrush if the liquid contents are paint, (c) an applicator if the contents are a face crème, (d) a sponge or brush if the contents are a shoe polish; and (e) a toothbrush if the contents are toothpaste, etc. In this manner advantageously, the utility of the container is increased while almost no cost is added. Said compartment may open out according to a number of means, including but not limited to having an opening flap utilizing the container wall as a live hinge, a zip, or a pull-out drawer. Furthermore, said compartment can be formed either as part of the container body 10 or within the pumping assembly 17.

The dispensing container of the present invention can be used to dispense small quantities of liquids such as, for example, a sauce, a crème, a shampoo, a liquid soap, a shaving gel, a hair conditioner, either oil-based or water-based paints, shoe polish, toothpaste, or any liquid comestible substance, etc.

A further enhancement of the package of the present invention involves the inclusion of an electronic module, which may or not be interfaced with any of the valves described above. Said electronic module can serve as a timer, dosage counter, freshness indicator, or cold-chain monitor; or may implement any combination of these functions. In the case that the liquid in the container is a medication, a timer can serve the important function of alerting the patient to the need to take the next dose.

It should be apparent to one versed in the art that the container of the present invention can be a part of another product such as a cartridge for a dispensing machine or a complex machine that requires the dispensing of doses of liquid.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A container having a dispensing outlet, a section of said container adjacent to said outlet being provided with a pumping assembly sized to be insertable into said section via said outlet and further being provided with a pumping button; wherein said button is a section of the container wall and depression of said button actuates said pumping assembly.

2. A container according to claim 1 comprising a tube-like container, a pumping assembly inserted into an open end of said container at time of fabrication, and a pumping button; wherein said button is a section of the tube wall and depression of said button actuates said pumping assembly.

3. A container according to claim 1 where said pumping assembly comprises a pumping chamber, a non-return inlet valve leading into the interior of the container non-return outlet valve leading to dispensing outlet of said container.

4. A dispensing container according to claim 3 where said button is aligned with said pumping chamber such that depression of said button serves to actuate a pumping mechanism formed there between.

5. A dispensing container according to claim 3 where said pumping assembly further comprises an air compensation valve such that air replaces the contents of the container as said contents are dispensed.

6. A dispensing container according to claim 1 where said button is a formed section of said container wall where said forming is accomplished using means selected from the group consisting of thermoforming, embossing, blow-molding and injection blow-molding.

7. A dispensing container according to claim 1 where said button is a marked, non-formed section of said container wall.

8. A dispensing container according to claim 1 where said pumping assembly comprises a single plastic component surrounded by an elastomeric diaphragm; wherein said diaphragm serves to complete at least one valve.

9. A dispensing container according to claim 1 where said pumping assembly comprises a single, hinged plastic component with integral valve sections, said valves being assembled by closing said hinge.

10. A dispensing container according to claim 1 where said pumping assembly comprises two plastic components with integral valve sections, said valves being fabricated by assembling said components.

11. A dispensing container according to claim 1 where said pumping assembly comprises a component which is head-injected into said container, optionally further comprising additional parts subsequently attached to said head-injected component.

12. A dispensing container according to claim 1 where said dispensing outlet operates through a notch in said container wall.

13. A dispensing container according to claim 1 where said dispensing outlet further comprises a tamper-evident seal.

14. A dispensing container according to claim 3 where said outlet valve comprises a pressure valve wherein pressure from the interior of the container serves to close said valve, thereby preventing unintended dispensing of the contents.

15. A dispensing container according to claim 1 further comprising an additional button, said button also actuating said pumping assembly; such that depressing both buttons increases the amount of content dispensed.

16. A dispensing container according to claim 1 further comprising a plurality of additional pumping assemblies and buttons, such that a plurality of substances can be dispensed separately.

17. A dispensing container according to claim 1 further comprising a plurality of inner container sleeves, such that at a plurality of different substances may be dispensed together.

18. A dispensing container according to claim 1 further comprising a plurality of inner container sleeves, such that a plurality of different substances may be mixed prior to application and dispensed together.

19. A dispensing container according to claim 3 further comprising an inner container sleeve where said inner container sleeve collapses as the contents of said inner container sleeve are dispensed while the external container wall maintains its shape.

20. A dispensing container according to claim 1 further comprising a piston as the far end of the container, where said piston advances as the contents of said container are dispensed, such that the container maintains its shape.

21. A dispensing container according to claim 3 wherein depression of the button to its depressed position causes the contents of said pumping chamber to be expelled via said non-return outlet valve and return of said button to its initial position causes the contents of said container to enter said pumping chamber via said inlet valve.

22. A dispensing container according to claim 1 where said dispensing container is fabricated by the insertion of a pumping assembly into a neck portion of said container.

23. A dispensing container according to claim 1, wherein said liquid is one of the group comprising a perfume, an eau de toilet, a breath freshener, a shampoo, a liquid soap, a shaving gel, a hair conditioner, a comestible substance, snuff, an inhalable medicine, an oil, water-based paint, oil-based paint or shoe polish.

24. A dispensing container according to claim 1, further provided with a manually actuated safety valve which cannot be operated by a young child.

25. A dispensing container according to claim. 1 where said container is of a shape selected from the group consisting of plastic containers, laminate containers, tubes and tottles.

26. A dispensing container according to claim 1, further comprising an isolated compartment within the body of the container; said compartment containing an item to be used in conjunction with the contents of said container.

27. A dispensing container according to claim 1, further comprising a shipping seal in the form of a tape; said tape being adhered to a section of said container such that said tape covers said dispensing outlet.

28. A dispensing container according to claim 9 where said plastic component further comprises an integral spring.

29. A dispensing container according to claim 1, wherein said section of said container adjacent to said outlet is a neck area thereof.
